(19) United States
(12) Patent Application Publication
(10) Pub. No.: US 2003/0201656 A1
(43) Pub. Date: Oct. 30, 2003

(54) Removable rack assembly for holding ladders in a truck bed

(76) Inventors: Betty L. Ferguson, St. Charles, MO (US); James L. Ferguson, St. Charles, MO (US); Betty L. Ferguson, St, Charles, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/422,173

(22) Filed: Apr. 24, 2003

Related U.S. Application Data
(60) Provisional application No. 60/375,086, filed on Apr. 24, 2002.

(51) Int. Cl. B60P 3/00

(52) U.S. Cl. 296/3

(57) ABSTRACT

A removable ladder rack assembly for removable installation in the bed of a pick-up truck or on a van comprising brackets positioned along one side of a truck bed or along both sides. The brackets are fastened to the truck and upright supports are removably locked to the brackets. Adjacent to the tops of the brackets are positioned inwardly directed extensible arms which extend over the bed. If the brackets are positioned on both sides of the bed opposite to each other, a full set extension bar can be positioned between the fixed arms and removably locked thereto. Upward extensions on the upright supports and the arms help retain the ladders on the rack assembly.

### CROSS REFERENCE TO RELATED APPLICATIONS

This application claims priority from U.S. provisional application serial No. 60/375,086 filed Apr. 24, 2002.

### STATEMENT REGARDING FEDERALLY SPONSORED RESEARCH OR DEVELOPMENT

Not Applicable

### BRIEF SUMMARY OF THE INVENTION

This invention is directed to a ladder carrying assembly which is mounted in the bed of a pick-up truck or a van. In particular, this rack assembly is designed to be easily removable from the truck bed or van, thus allowing the truck or van to be used for any conventional use without the rack assembly intruding.

### BACKGROUND OF THE INVENTION

Pick-up trucks conventionally are used for many purposes. One of these purposes can be to carry a ladder or series of ladders. However, it often is desirable that the truck be free of obstructions that the ladder holders may cause. Accordingly this invention provides a sturdy rack assembly which can be easily installed and removed from a pick up truck.

The assembly includes a front rack and a rear rack designed to be removably fastened to holsters mounted in the truck bed. The rack has an upright leg which fits into the holsters and an extendible right angular support bar mounted on the top of the upright and directed toward the center of the bed.

A rack assembly set can be mounted on one side of a truck bed, on both sides of the bed or a full-set extension bar can be positioned in opposed right angular support bars of sets of rack assemblies mounted across from one another in the truck bed to make a full-ladder truck.

### BRIEF DESCRIPTION OF THE SEVERAL VIEWS OF THE DRAWINGS

In the accompanying drawings which form part of the specification:

The drawings and photographs show the installation of the rack assemblies in the bed of a pick-up truck.

Fig. A shows a pick-up truck having rack assemblies on both sides with a ladder on the right side rack with the rack extension in extended position. The extensions of the rack assemblies on the left side of the truck bed are not extended;

FIG. 1 shows a fragmentary rear elevational view taken from the back of a pick-up truck showing a full-rack extension;

FIG. 1A is a fragmentary enlarged elevational view showing the fastening of the brackets to the truck bed;

FIG. 1B is a fragmentary side elevational view taken from inside the fastening of the truck bed,

FIG. 1C is a fragmentary plan view of a full rack extension;

FIG. 2 is a fragmentary rear elevational view from the back of a pick-up truck showing a rack on one side of a truck bed;

FIG. 2A is similar to FIG. 1A;

FIG. 2B is similar to FIG. 1B; and

FIG. 2C is a plan view similar to FIG. 1C.

Corresponding reference numerals indicate corresponding parts throughout the several figures of the drawings.

### DETAILED DESCRIPTION OF INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The rack assembly “A” is shown in Fig. A applied to a pick-up truck 1 having a bed 2 which includes a floor panel 3, side walls 4 and a tailgate 5. Connected to the bed 2 is a cab 6.

The rack assembly “A” includes a bed bracket 10 that has a foot 11 which is fastened to the floor 3 of the pick-up bed 2 by a fastener 12, such as bolts or welds. The bracket 10 itself is a square tube which receives a square tube upright leg 13 which is part of the rack assembly “A”. The upright 13 and the bracket 10 have aligned openings which receive a removable retaining pin 14.

An upper bracket or holster 20 is mounted on the truck bed side wall 4 by a fastener 22, such as bolts or welds. The bracket 20 is a square tube. The upright 13 also is positioned in the upper bracket 20 and is removably secured thereto by a threaded “T” handle 23.

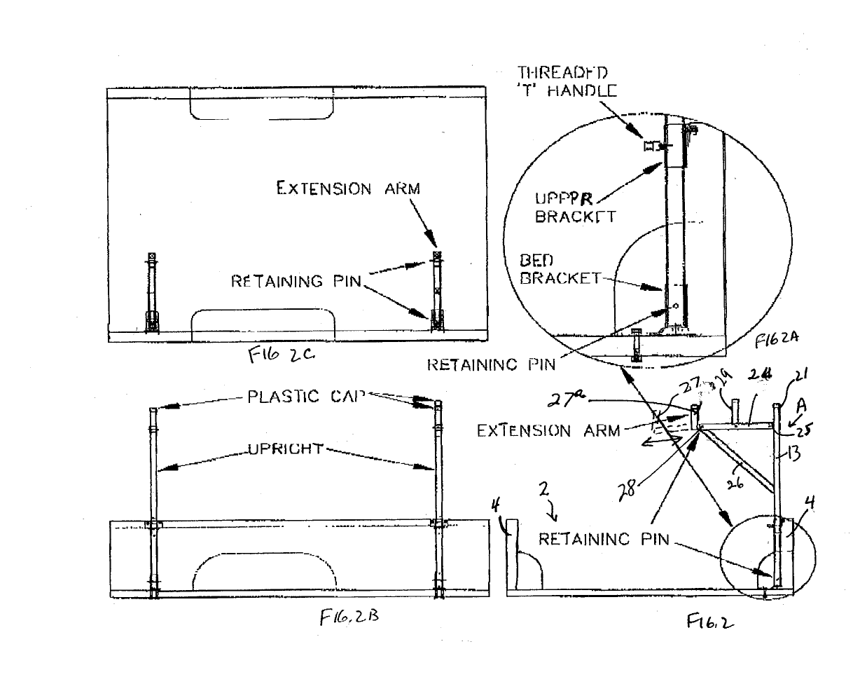

FIGS. 2-2C show a rack support assembly “A” mounted on one side of a truck bed 2. Adjacent to the top 21 of the upright leg is a right angularly positioned ladder support bar 24 which is directed toward the opposite side of the truck 1. The bar 24 is fixed at one end 25 to the upright leg 13. The opposite end is fixed to the upright leg 13 by an angular brace 26. An extension arm 27 is movably positioned in the end of the support bar 24 and is movable to the position shown by the broken lines in FIG. 2 to give a longer support surface to accommodate wider ladders. A removable retaining pin 28 fits into aligned openings in the bar 25 and the extension arm 27 to hold the arm 27 in the desired position. This allows adjustment of the rack to fit the size ladder being carried.

Both the bar 24 and extension arm 27 preferably are square tubular members and the arm 27 telescopes inside the bar 27. The arm 27 has an upring member 27a at its end to help retain ladders when in extended position.

An upright retainer 29 is located on the bar 25 of the assembly A adjacent to the truck cab 6 to keep the ladders from moving forward or backward on the rack assembly.

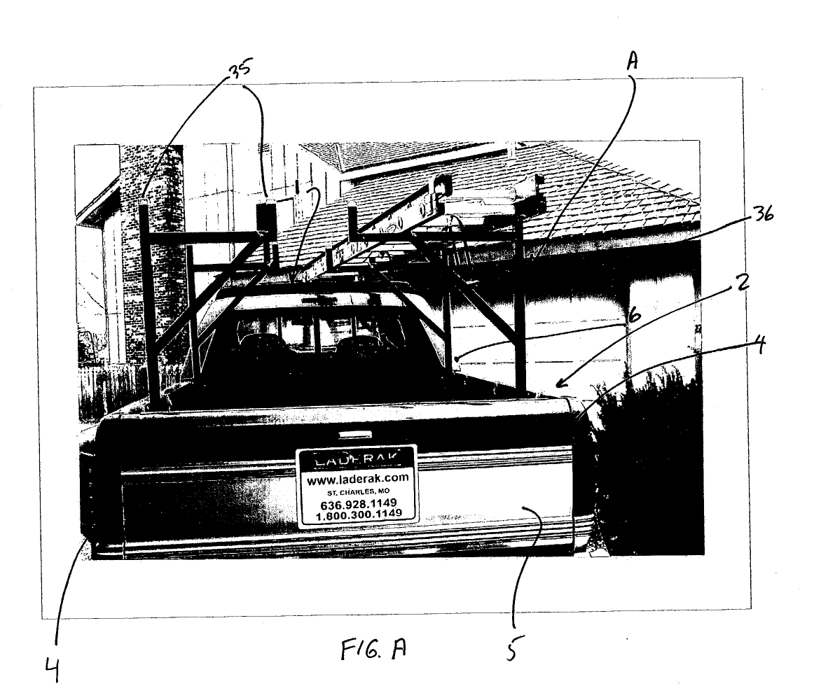

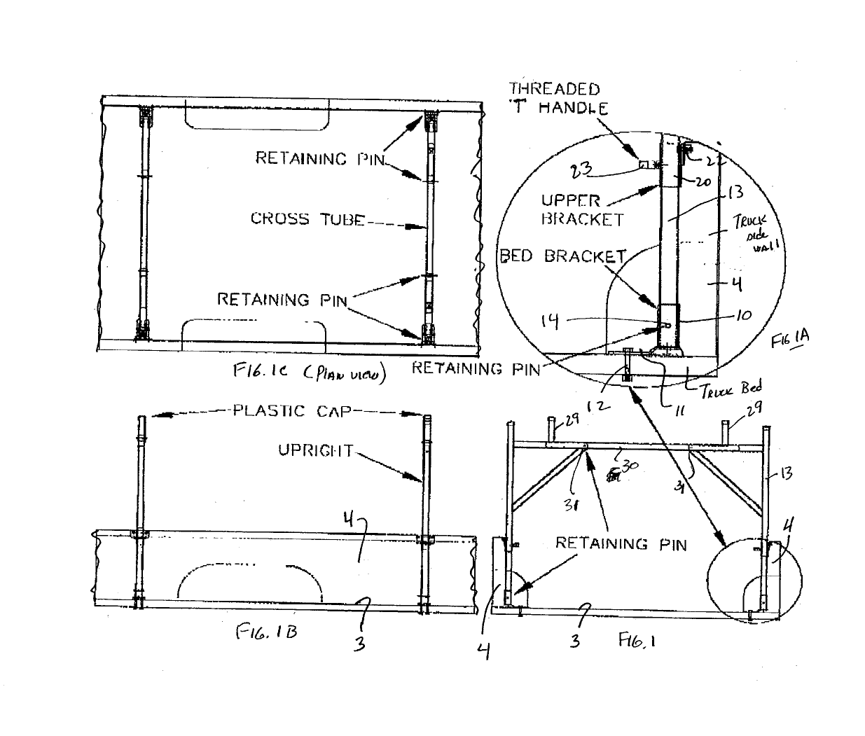

One of the foregoing described assemblies A is positioned at the front (nearer the cab 6) and at the back (near the tailgate 5) of the truck bed on the same side. Alternatively the assemblies A can be positioned on both sides 4 of the truck bed 2 opposite each other. When so positioned the truck 1 can be transformed to a full-ladder truck by removing the extension arms 27 and replacing them with a full-set extension bar 30 (FIG. 1) which is custom fitted to the truck bed width and secured in place with retaining pins 31.

Preferably the rack assemblies “A” are installed such that the ladder support bar 24 and the extension arm 27 are higher than the top of the cab 6 so that the ladders do not engage the cab top and can extend over the top.

To install a set of the rack assemblies “A”, the brackets 10 are mounted in the bed 2 of the truck using the L-shaped base 11 at the junction of the bottom 3 and sides 4 of the bed 2. Exact placement depends on location of the gas tanks, wiring, etc. on each individual truck. Directly above that, the top holster bracket 20 is installed; both are screwed into the bed and sides of the truck. The ladder rack assembly “A” then is positioned in the holsters 10, 20, and the safety pin 14 is inserted into the holes in the bottom bracket 10 of the holster to secure the rack. The extension bar 27 then is added to the rack assembly “A” and a safety pin 28 is inserted into one of the two holes to secure the extension bar 27 in whichever position fits the ladder currently being carried. Caps 35 are provided for the top of each leg and each upright retainer 29, 27a of the rack assembly “A”.

To install a full-set, the holsters 10, 20 are installed directly across from each other on both sides 4 of the truck bed 2, making sure they are level and evenly mounted. The regular extension bars are not inserted, but instead a full-set extension bar 30 is added. Once this full-set extension bar 30 is custom fitted to a truck, only safety pins 31 are needed on both sides, fastened securely.

The rack assemblies “A” are removed by simply pulling all of the safety or retaining pins out, loosening the T-handle on the top holsters or upper brackets and lifting out the uprights.

A removable tie strap 35 is used to secure the ladders to the rack bar 25 by looping the strap around the bar 25 and a rung of the ladder and securing the ends together,

These rack assemblies are more easily removed and at a lower cost than other ladder supports. A single or full-set can be removed in a matter of minutes and the truck used for other purposes.

The rack assemblies are powder-coated to withstand the elements and can be made from aluminum or steel.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

What is claimed is:

1. In a pickup truck having a bed and a cab the improvement comprising a removable ladder rack which comprises
a plurality of brackets mounted adjacent to a side wall of said bed, one of said brackets being closer to the cab of said truck and another of said brackets being closer to the tailgate of said bed,
upright supports removable positioned in said brackets,
means for releasibly locking said supports in said brackets, and
side arms on said brackets extending parallel to and above the bed for supporting ladders.

2. The improvement of claim 1 wherein said brackets comprise a base having an opening for an upright support and a holster vertically aligned with the base and also having an opening through which the upright support extends.

3. The improvement of claim 2 wherein the base is L-shaped and is positionable at the junction of the bottom and side wall of the bed.

4. The improvement of claim 3 including a lock pin removably positioned through the base and the upright support.

5. The improvement of claim 2 including a threaded lock pin removable positioned in the holster and the upright.

6. The improvement of claim 1 including extension bars on the side arms to accommodate different width ladders.

7. The improvement of claim 6 wherein the extension bars telescope with the side arms and including removable lock pins positionable in the side arms and extension bars to lock the extension bars in place.

8. The improvement of claim 6 including upright members on the extension bars and the brackets to hold the ladders in position.

9. The improvement of claim 1 including pairs of removable ladder racks directly opposed to each other adjacent opposite side walls of the bed with side arms extending toward each other.

10. The improvement of claim 9 including a full set extension bar positioned between the opposed side arms and removably locked thereto.

11. The improvement of claim 8 including a third upright on one of the side arms to assist in locking the ladders in place.

12. The improvement of claim 1 including support arms positioned between the upright supports and the free ends of the side arms.

13. A removable ladder rack assembly adapted to be removably installed in the bed of a pick-up truck comprising brackets having an upright opening and adapted to be installed in the back of a pick-up truck adjacent to the cab and the tailgate,
upright supports adapted to be removable positioned in the bracket openings;
means for releasibly locking the supports in the brackets; and
side arms on the brackets extending parallel to and above the bed of the truck for holding ladders.

14. The assembly of claim 13 wherein the side arms are positioned such that the ladders ride higher than the cab of the truck.
